(19) United States
(12) Patent Application Publication
(10) Pub. No.: US 2008/0049586 A1
(43) Pub. Date: Feb. 28, 2008

(54) OPTICAL PICKUP APPARATUS AND OPTICAL INFORMATION RECORDING/REPRODUCING APPARATUS

(76) Inventor: So ISHIKA, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/839,192

(22) Filed: Aug. 15, 2007

(30) Foreign Application Priority Data
Aug. 25, 2006 (JP) 2006-229564

(51) Int. Cl. G11B 7/135

(52) U.S. Cl. 369/112.24

(57) ABSTRACT

According to one embodiment, an optical pickup apparatus and an optical information recording/reproducing apparatus including an embodiment of the present invention has an objective lens for condensing a laser beam on a recording surface of an information recording medium (an optical disc), a collimator lens for collimating a laser beam guided to an objective lens, a magnification change lens which gives a predetermined convergency to a laser beam guided from a light source to a collimator lens, and leaves divergence after the laser beam passes a collimator lens, and an optical path length correction mechanism for changing an optical path length of a reflected laser beam that is a laser beam condensed and reflected from a recording surface of a medium through a magnification change lens.

### CROSS-REFERENCE TO RELATED APPLICATIONS

This application is based upon and claims the benefit of priority from Japanese Patent Application No. 2006-229564, filed Aug. 25, 2006, the entire contents of which are incorporated herein by reference.

### BACKGROUND

1. Field

One embodiment of the present invention relates to recording or reproducing information in/from optical discs with different thickness. In particular, the present invention relates to an optical pickup apparatus and an optical information recording/reproducing apparatus capable of processing all laser beam wavelengths used for recording/reproducing with a single detector.

2. Description of the Related Art

A long time has been past since practical use of an optical disc (e.g., a CD-standard optical disc) for recording or reproducing information by using a laser beam, and an optical disc apparatus (optical disc drive) for recording or reproducing information in/from an optical disc. In addition to a CD-standard disc, an optical disc called a DVD having a high recording density is widely used.

Recently, an optical disc called a High Definition (HD) DVD (hereinafter, HD DVD) has been put into practical used. An HD DVD increases the recording density by recording information using a short-wavelength blue or purple laser beam.

It is inefficient to prepare an optical disc apparatus (disc drive) for various kinds of optical disc from the viewpoint of cost and installation place. Therefore, it is desired to record, reproduce or erase information in/from all kinds of optical disc.

For example, Japanese Patent Application Publication (KOKAI) No. 2004-103135 has proposed an optical pickup, which divides three laser beam wavelengths of long (for CD), middle (for DVD) and short (for HD DVD) into two groups, and shares optical elements for two laser beam wavelengths.

Japanese Patent Application Publication (KOKAI) No. 2005-141884 has proposed an optical pickup comprising a first semiconductor laser beam source to emit a laser beam in the 405-nm band, a second semiconductor laser beam source to emit a laser beam in the 650-nm band, an optical path synthesizing means to synthesize optical paths of laser beams of each waveband, an objective lens to focus each laser beam as an image on an optical information recording medium, a light-receiving element to receive a laser beam reflected from an optical information recording medium and to detect optical information, an optical path branching means to branch an optical path from each semiconductor laser beam source to an optical information recording medium and an optical path from an optical information recording medium to the light-receiving element, wherein a filter means for adjusting the amount of transmitted light in the 405- and 650-nm bands is provided between the optical path branching means and light-receiving element.

Japanese Patent Application Publication (KOKAI) No. 2004-185781 has proposed an optical pickup using the same optical axis for a red optical beam for DVD and a blue optical beam for HD DVD, in which a pair of beam expander lenses is provided before and after a dichroic prism, spherical aberration occurring in a blue light beam is corrected, and each optical beam is made as a parallel beam.

However, the optical pickup of the publication No. 2004-103135 needs three channels of a photodetector IC (PDIC) that is a light-receiving unit.

The optical pickup of the publication No. 2005-141884 is difficult to provide a magnification change lens to increase the efficiency of using light with respect to an infrared light (a laser beam for a CD-standard optical disc).

The publication No. 2004-185781 merely discloses an optical pickup, in which the same optical axis is used for a red optical beam for DVD and a blue optical beam for high-density recording, but does not refer to a method of detecting with a single PDIC three laser beam wavelengths, including 785 nm for the widely used CD-standard optical disc.

Namely, none of the above patent documents discusses a method or possibility of detecting with a single PDIC three laser beam wavelengths corresponding to the CD, DVD and HD DVD optical disc standards.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIGS. 1A and 1B are exemplary diagrams showing an example of an optical pickup apparatus according to an embodiment of the invention;

FIG. 2 is a graph showing an example of spectral characteristics of a first prism of the optical pickup apparatus shown in FIGS. 1A and 1B, according to an embodiment of the invention;

FIG. 3 is a graph showing an example of spectral characteristics of a second prism of the optical pickup apparatus shown in FIGS. 1A and 1B, according to an embodiment of the invention;

FIG. 4 is a graph showing examples of a beam splitter of the optical pickup apparatus shown in FIGS. 1A and 1B, according to an embodiment of the invention;

FIGS. 5A and 5B are exemplary diagrams showing an example of an optical pickup apparatus according to an embodiment of the invention;

FIGS. 6A and 6B are exemplary diagrams showing an example of an optical pickup apparatus according to an embodiment of the invention;

FIGS. 7A and 7B are exemplary diagrams showing an example of an optical pickup apparatus according to an embodiment of the invention;

FIGS. 8A and 8B are exemplary diagrams showing an example of an optical pickup apparatus according to an embodiment of the invention; and

FIG. 9 is an exemplary diagram showing an example of an information recording/reproducing apparatus including an optical pickup apparatus according to an embodiment of the invention.

### DETAILED DESCRIPTION

Various embodiments according to the invention will be described hereinafter with reference to the accompanying drawings. In general, according to one embodiment of the invention, an information playback apparatus comprising: a disk drive unit configured to read information from a disk-shaped recording medium; an information playback main unit holding the disk drive unit and configured to supply a display unit with an output of the disk drive unit in a state in which the output is permitted to be displayed on the display unit; and an interface holding shared key information shared between the disk drive unit and the information playback main unit, the interface being configured at least to supply the shared key information to the information playback main unit, and to transfer the shared key information from the information playback main unit to the disk drive unit.

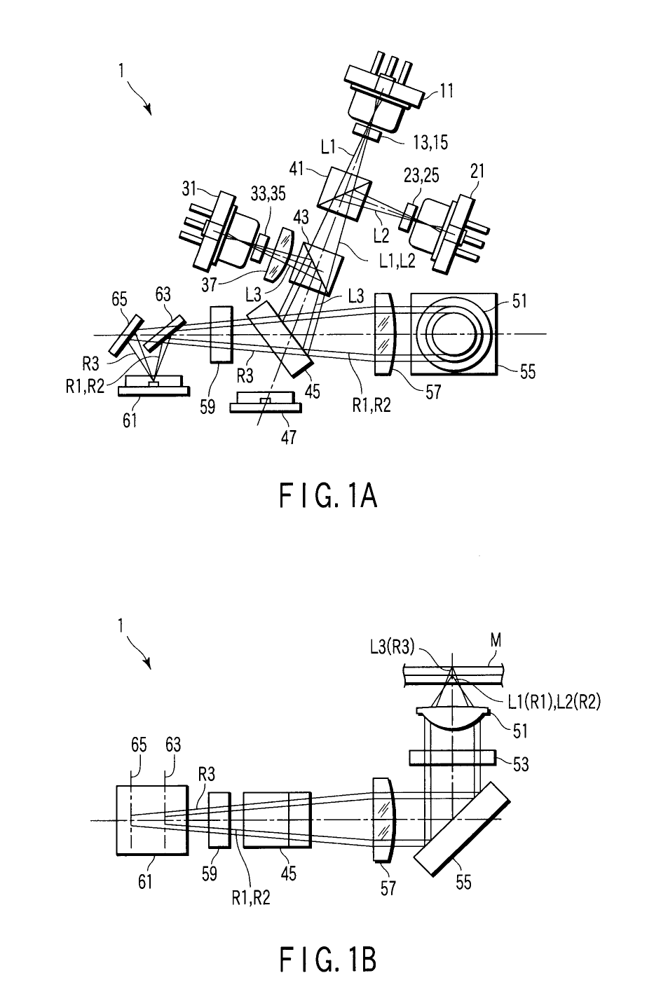

According to an embodiment, FIGS. 1A and 1B show an example of an optical pickup apparatus according to an embodiment of the invention. FIG. 1A shows the optical pickup apparatus viewed from the direction perpendicular to the recording surface of a medium, i.e., an optical information recording medium, or an optical disc (viewing the X-Y plane). FIG. 1B shows the optical pickup apparatus viewed from the direction parallel to the recording surface of a medium, i.e., optical disc (viewing the Y-Z plane).

As shown in FIGS. 1A and 1B, an optical pickup apparatus 1 has a first semiconductor laser beam source 11 to emit a first-wavelength laser beam L1 in the 405-nm band, a second semiconductor laser beam source 21 to emit a second-wavelength laser beam L2 in the 660-nm band, and a third semiconductor laser beam source 31 to emit a third-wavelength laser beam L3 in the 780-nm band, for example.

The first-wavelength laser beam L1 emitted from the first semiconductor laser beam source 11 is passed through a first prism 41 and a second prism 43, partially reflected by a beam splitter 45, and guided to an objective lens 51. Between the objective lens 51 and beam splitter 45, a λ/4 plate (polarizing element) 53, an optical path changing (rising) mirror 55 and a collimator lens 57 are arranged sequentially from the objective lens side. The first laser beam L1 actually guided to the objective lens 51 is converted to substantially parallel beam by the collimator lens 57, changed in the advancing direction by the mirror 55, rotated by 45° in the wavefront polarizing direction by the λ/4 plate 53, and applied to the objective lens 51.

The laser beam L1 guided to the objective lens 51 is converged to a predetermined spot size (a wavefront sectional beam diameter upon focusing) by the power of the objective lens 51, and condensed on the recording surface of an optical disc M. As for the objective lens 51, not only a single lens type but also a twin lens type is usable, as long as it is a wavelength conversion type.

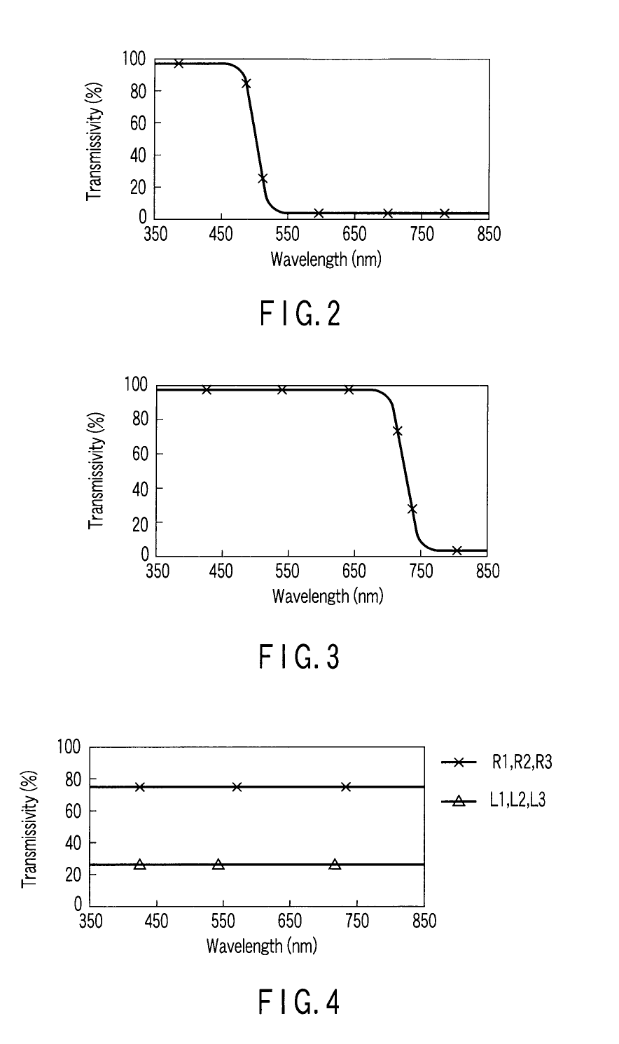

The first prism 41 is given characteristics to reverse the amount of transmitted and reflected light of wavelength close to 450 nm as shown in FIG. 2, in order to transmit the laser beam L1 in the 405-nm band from the first laser beam source 11, and reflects the laser beam L2 in the 660-nm band from the second laser beam source 21. The first prism 41 is easily made by laminating two glass prisms through a not-shown dichroic film that is a multilayer optical thin film, for example. It is of course permissible to provide a dichroic film on one side of a single prism. The wavelength selectivity of a dichroic film is defined so that the transmissivity of an S-polarized laser beam of wavelength 405 nm becomes almost 100%, and the reflectivity of an S-polarized laser beam of wavelength 660 nm becomes almost 100%.

The first laser beam L1 output from the first semiconductor laser beam source 11 is a divergent luminous flux with a substantially elliptic wavefront shape. It is known that in the wavefront of a laser beam output from the semiconductor laser source, the short axis direction of the ellipse is parallel to the direction of spreading an active layer surface of a laser element, and becomes a linear polarized light extending in the active layer surface spreading direction. Therefore, the polarizing direction of the laser beam L1 can be set to a desired direction by rotating the laser beam source 11 about the optical axis (a line segment connecting the laser beam source 11 and beam splitter 45).

Between the first laser beam source 11 and prism 41, preferably at a predetermined position in proximity to the laser beam source 11, a λ/2 plate 13 is provided to rotate the wavefront polarizing direction of the laser beam L1 by 90°, and the wavefront polarizing direction is adjusted to a predetermined direction so that a laser beam directed to the recording layer of the medium (optical disc) M by the beam splitter 45 can be separated from a laser beam reflected from the medium (optical disc) M. Namely, the polarizing direction of the laser beam L1 emitted from the semiconductor laser beam source 11 is adjusted by the λ/2 plate 13 (the ratio of P- to S-polarized light is changed to a predetermined ratio).

In proximity to the λ/2 plate 13, there is also provided a diffraction grating 15 which divides the wavefront of the reflected laser beam reflected from the recording layer of the optical disc (medium) M into two or more portions for later signal processing. The λ/2 plate 13 and diffraction grating 15 may be formed as one body. For example, a predetermined diffraction pattern may be given by hologram on an optional plane of the λ/2 plate 13. When a diffraction pattern is a blaze type or binary type, the pattern may be formed directly on an optional plane of λ/2 plate 13.

The second-wavelength laser beam L2 emitted from the second semiconductor laser beam source 21 is bent by the first prism 41, passed through the second prism 43, partially reflected by the beam splitter 45, and guided to the objective lens 51. The second laser beam L2 guided to the objected lens 51 is converged to a predetermined spot size by the objective lens 51, and condensed on the recording surface of the optical disc M. Namely, the second laser beam L2 is laid over the first laser beam L1 by the first prism 41, and guided to the recording surface of the optical disc M on substantially the same optical path as the first laser beam L1.

The second laser beam L2 output from the second semiconductor laser beam source 21 is a divergent luminous flux with a substantially elliptic wavefront shape, like the first laser beam L1. It is known that in the wavefront of a laser beam L2, the short axis direction of the ellipse is parallel to the direction of spreading an active layer surface of a laser element, and becomes a linear polarized light (P-polarized light) extending in the active layer surface spreading direction, like the first laser beam L1. Between the second laser beam source 21 and prism 41, preferably at a predetermined position in proximity to the laser beam source 21, a λ/2 plate 23 is provided to rotate the wavefront polarizing direction of the laser beam L2 by 90°, and the wavefront polarizing direction is adjusted to a predetermined direction so that a laser beam directed to the recording layer of the medium (optical disc) M by the beam splitter 45 can be separated from a laser beam reflected from the medium (optical disc) M.

In proximity to the λ/2 plate 23, there is also provided a diffraction grating 25 which divides the wavefront of the reflected laser beam reflected from the recording layer of the optical disc (medium) M into two or more portions for later signal processing. The λ/2 plate 23 and diffraction grating 25 may be formed as one body. For example, a predetermined diffraction pattern may be given by hologram on an optional plane of the λ/2 plate 23. When a diffraction pattern exists, the pattern may be formed directly on an optional plane of λ/2 plate 23.

The third-wavelength laser beam L3 emitted from the third semiconductor laser beam source 31 is bent by the second prism 43, laid over the first and second laser beams L1 and L2, partially reflected by the beam splitter 45, and guided to the objective lens 51. Namely, the third laser beam L3 is guided to the recording surface of the optical disc M on substantially the same optical path as the first laser beam L1 (or the second laser beam L2).

The third laser beam L3 output from the third semiconductor laser beam source 31 is also a divergent luminous flux with a substantially elliptic wavefront shape, like the first and second laser beams L1 and L2. It is also known that in the wavefront of a laser beam L3, the short axis direction of the ellipse is parallel to the direction of spreading an active layer surface of a laser element, and becomes a linear polarized light (P-polarized light) extending in the active layer surface spreading direction, like the first and second laser beams L1 and L2. Between the third laser beam source 31 and prism 43, preferably at a predetermined position in proximity to the laser beam source 31, a λ/2 plate 33 is provided to rotate the wavefront polarizing direction of the laser beam L3 by 90°, and the wavefront polarizing direction is adjusted to a predetermined direction so that a laser beam directed to the recording layer of the medium (optical disc) M by the beam splitter 45 can be separated from a laser beam reflected from the medium (optical disc) M.

In proximity to the λ/2 plate 33, there is also provided a diffraction grating 35 which divides the wavefront of the reflected laser beam reflected from the recording layer of the optical disc (medium) M into two or more portions for later signal processing. The λ/2 plate 33 and diffraction grating 35 may be formed as one body, like the first and second laser beams L1 and L2 explained before. For example, a predetermined diffraction pattern may be given by hologram on an optional plane of the λ/2 plate 33. When a diffraction pattern is a blaze type or binary type, the pattern may be formed directly on an optional plane of λ/2 plate 33.

The second prism 43 is given characteristics to invert the amount of transmitted and reflected light of wavelength close to 700-750 nm, as shown in FIG. 3, to pass the laser beam L1 of wavelength 405 nm from the first laser beam source 11 and laser beam L12 of wavelength 660 nm from the second laser beam source 21, and to reflect the laser beam L3 of wavelength 780 nm from the third laser beam source 31. Like the first prism 41, the second prism 43 is easily formed by laminating two glass prisms through a not-shown dichroic film that is a multilayer optical thin film, for example.

Between the third semiconductor laser beam source 31 and second prism 43, preferably between the diffraction rating 35 and second prism 43, a magnification change lens 37 is provided. The magnification change lens 37 is used to shift the condensing position of the laser beam L3 of wavelength 780 nm from the third semiconductor laser beam source 31 to the rear of the laser beams L1 and L2 from the first and second semiconductor laser beam sources 11 and 21 (to hold the state that divergence is left when entering the objective lens 51).

Namely, by using the magnification change lens 37, in the example shown in FIGS. 1A and 1B, the laser beam L3 of wavelength 780 nm is non-parallel light at the time when entering the objective lens 51 (the sectional diameter of the laser beam L3 is reduced to smaller than the diameters of the laser beams L1 and L2, until it is reflected from the beam split side of the second prism 43 and applied to the objective lens 51).

As described above, the first to third laser beams L1, L2 and L3 guided on substantially the same optical path are guided to the beam splitter 45, and led to the objective lens 51 (and the recording surface of the optical disc M when the disc is mounted), as explained above. An optional one of three semiconductor laser beam sources 11, 21 and 31 is selectively activated based on the standard of a medium (optical disc) M prepared for recording or reproducing information. Therefore, it is of course impossible that laser beams of different wavelengths are emitted at the same time from two or more light sources.

The beam splitter 45 is formed by laminating a polarization separation film that is a not-shown multilayer optical thin film on one side 451 of a parallel flat plate (a plate-like glass or resin having a parallel plane). The beam splitter reflects a P- or S-polarized component of an incident laser beam, particularly an S-polarized component (by the polarization separation film) by more than a certain amount irrespectively of a wavelength, and passes a predetermined ratio of the P- and S-polarized components. Namely, the beam splitter 45 is given a characteristic to pass about 80% of S-polarized component regardless of a wavelength, and to reflect the remainder, as shown in FIG. 4. The other side 45o of the parallel flat plate is coated with a reflection preventive film that is a not-shown multilayer optical thin film is formed on the other side 45o of the parallel flat plate, to prevent the laser beam applied from the side 45i with a polarizing separation film formed thereon to the inside, from reflecting inside the side 45o and emitting again from the side 451. The beam splitter 45 is desirably arranged non-parallel to an optical axis connecting the first and second prisms 41 and 43, in order to prevent the laser beam reflected undesirably on the incident side plane 451 (or exit side plane 45o) from returning to a not-shown monitoring detector of a semiconductor laser beam source as an output source, fluctuating in the strength of the laser beam output (from that semiconductor laser beam source), and acting as a ghost component to the objective lent 51 (and optical disc M).

An optional laser beam L1 or L2 (or L3) guided to the beam splitter 45 is reflected from the incident side plane 451 of the beam splitter 45, collimated by the collimator lens 57, and guided to the rising (optical path changing) mirror 55.

A part of the laser beam L1 or L2 (or L3) guided to the beam splitter 45 simply passes through the beam splitter 45, and guided to a light amount monitoring light-receiving element PDIC (Photodetector IC for monitoring 47) which is located on the opposite side to the first and second prisms 41 and 43 with respect to the beam splitter 45, and used as a monitor for keeping the light amount (intensity) of the laser beam L1, L2 or L3 from the first to third semiconductor laser beam sources 11, 21 and 31, that is, the output of each light source (the laser beam strength) within a certain range.

The laser beam guided to the rising (optical path changing) mirror 55 is bent (by the mirror 55) toward the recording surface of the optical disc (medium) M. The laser beam L1 or L2 (or L3) bent by the mirror 55 is rotated 45° in the wavefront polarizing direction by the λ/4 plate (polarizing element) 53, and condensed (converged) in a predetermined spot size on the recording surface of the optical disc M by the convergence given by the objective lens 51.

The third laser beam L3 from the third semiconductor laser beam source 31 is guided to the objective lens 51 on substantially the same optical path as the first and second laser beams L1 and L2. Though the laser beam L3 is given a predetermined convergence by the collimator lens 57, the laser beam L3 is given a predetermined convergence (divergency in the sectional diameter of the laser beam) to become the state that divergence is slightly held though a predetermined convergence is given by the collimator lens 57 when entering the objective lens 51, and guided to the beam splitter 45, reflected from the beam splitter 45, and led to the objective lens 51.

Therefore, comparing the first and second laser beams L1 and L2, the third laser beam L3 is converged at a position separated from the objective lens 51. In this case, a spot size of the laser beam on the recording surface (a sectional diameter of the wavefront when condensing) is a suitable size recommended in a CD-standard optical disc. In the optical disc M capable of recording and reproducing information by using the first or second laser beam L1 or L2, the distance from a resin layer to a recording surface, or the thickness of a disc substrate is 0.6 mm. The thickness of a substrate of an optical disk using the third laser beam L3 is 1.2 mm. Therefore, the third laser beam L3 is condensed in a suitable spot size on the recording surface of an object CD-standard optical disc.

A laser beam (R1, R2 or R3) reflected from the recording surface of the optical disc (medium) M is captured by the objective lens 51, and passed through the λ/4 plate 53, thereby the wavefront polarizing direction is rotated by 45°. Therefore, the wavefront polarizing direction of the reflected laser beam is rotated by 90° with respect to the polarizing direction of a laser beam directed from the objective lens 51 to the recording surface of the optical disc M.

The reflected laser beam (R1, R2 or R3) captured by the objective lens 51 and changed in the advancing direction by the rising (optical path changing) mirror 55 is given a predetermined convergence (converged at a certain ratio) by the collimator lens 57, and returned to the beam splitter 45. Substantially the same convergence is given to the reflected laser beams R1 and R2, that is, the first and second laser beams L1 and L2 reflected from a recording surface of a disc.

Contrarily, the reflected laser beam R3, or the third laser beam L3 reflected from a recording surface of a disc is a non-parallel light at the time of entering the objective lens 51, and as it is reflected from the recording surface of a CD-standard optical disc whose substrate thickness is 1.2 mm, its sectional diameter on the beam split surface of the beam splitter 45 is larger than the sectional diameter of the reflected laser beams R1 and R2 with other wavelengths (the final image forming position is farther than the laser beams R1 and R2).

The reflected laser beams R1 and R2 guided to the beam splitter 45 are given a predetermined image forming characteristic by an astigmatic aberration sensor lens 59, and forms an image at a predetermined position in the PDIC (Photodetector IC) 61 as a light-receiving element. The reflected laser beams R1 and R2 are actually reflected from the first image forming mirror 63 toward the PDIC (light-receiving element), and form an image in the PDIC 61.

In contrast to the above, the laser beam R3 of wavelength 780 nm guided to the beam splitter 45 and reflected from the recording surface of a CD-standard optical disc is given a predetermined image forming characteristic by the astigmatic aberration sensor lens 59, passed through the first image forming mirror 63, reflected by the second image forming mirror 65, and forms an image in the PDIC 61.

Namely, reflected laser beams that are the first laser beam L1 in the 405-nm band and second laser beam L2 in the 660-nm band reflected from the recording surface of the optical disc M, and a reflected laser beam that is the third laser beam L3 in the 780-nm band reflected from the recording surface of the optical disc (CD standard) are separately reflected by the first and second image forming mirrors 63 and 65 according to the wavelength, thereby the difference in condensing distance is corrected, and images are formed in one PDIC 61.

The first image forming mirror 63 is required to substantially pass the reflected laser beam R3 or a laser beam in the 780-nm band, and to reflect a laser beam in a shorter-wavelength band than the 660-nm band. Thus, for example, a not-shown dichroic film that is a multilayer optical thin film to invert a reflection characteristic in the 700- to 750-nm band is used.

The first image forming mirror 63 is defined to a size not interrupt the optical path of the laser beam R3 in the 780-nm band reflected by the second image forming mirror 65 and directed to the PDIC 61, or a size to pass the whole sectional diameter of the laser beam R3. Namely, the third laser beam R3 may or not may pass through the first image forming mirror 63 or, when reflected by the second image forming mirror 65 and guided to the PDIC 61. In this case, if a part of the laser beam R3 is prevented from passing (crossing) through the first image forming mirror 63 the first image forming mirror 63, the size of the first image forming mirror 63 can be optionally set.

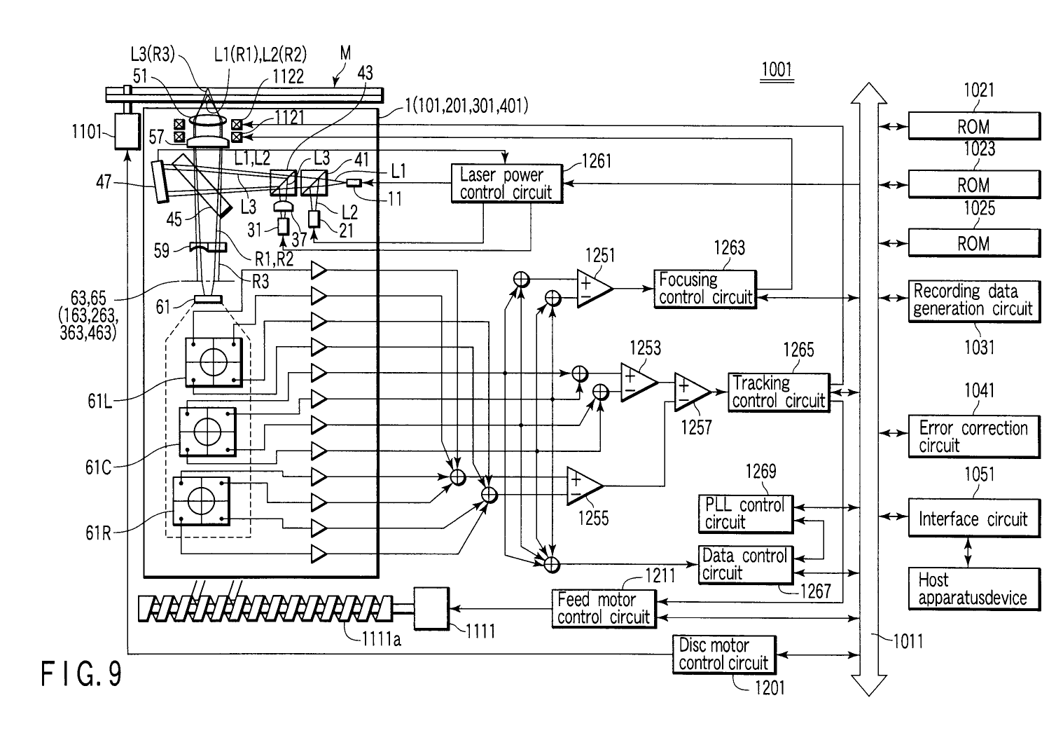

The PDIC 61 includes a multi-divided PIN photodiode given predetermined shape and area, and an I/V amplifier (current-voltage converter) to convert a current output from each photodiode to a voltage, for example, and outputs a voltage proportional to the intensity of a reflected laser beam applied to each PIN photodiode. A reflected laser beam that forms an image in the PDIC 61 is given a predetermined diffraction characteristic by the diffraction gratings 15, 25 and 35, when it is emitted from the semiconductor laser beam sources 11, 21 and 31. Thus, a reflected laser beam guided to the light-receiving surface of the PDIC 61 is wavefront split to a ±1^{st} diffracted light used for detecting a tracking error and a non-diffracted light (0^{th} diffracted light) used for detecting a focus error, for example, and forms an image in the PDIC 61. Therefore, by using the signal processing circuit shown in FIG. 9, for example, an information signal (RF output), focus error signal or track error signal is generated.

The astigmatic aberration lens 59 is useful to obtain a focus error signal by using astigmatic aberration component added to a reflected laser beam directed from the objective lens 51 to the PDIC 61, resulting from the beam splitter 45 shaped like a substantially parallel flat plate. Namely, as the beam splitter 45 is shaped like a parallel flat plate, a focus error signal can be obtained with a simple configuration.

As a method of detecting a tracking error, there is differential phase detection (DPD) and differential push-pull (DPP). When the medium (optical disc) M is a CD-standard disc and a laser beam of wavelength 780 nm is used, a well-known 3-beam method can be used for detecting a tracking error. When the medium (optical disc) M is a DVD-standard or HD DVD-standard disc and a laser beam of wavelength 660 or 405 nm is used, compensated push-pull (CPP) can be used for detecting a tracking error considering the influence of the lens shift of the objective lens 51.

As explained above, by using the optical pickup apparatus 1 shown in FIGS. 1A and 1B, and by shaping and arranging a not-shown photodetector (light-receiving) cell on the light-receiving surface of the PDIC 61 as predetermined, a reflected laser beam with an optical wavelength reflected from the recording surface of an optical disc can be received with a high efficiency, C/N higher than a certain level can be ensured to prevent required signals from being buried in noises, and various signals can be obtained. Namely, one channel of light-receiving element (single PDIC) can handle the signals from currently-used three kinds of optical disc (medium) M using three kinds of laser beams with different wavelengths when recording and reproducing information. It is also possible to correct the influence of fluctuations in the beam spot size when a reflected laser beam forms an image in the PDIC, resulting from the difference in the distance from the optical disc M to the recording layer, that is, the difference in the thickness of a layer to pass a laser beam. Therefore, information can be stably reproduced from the optical disc M of different standards.

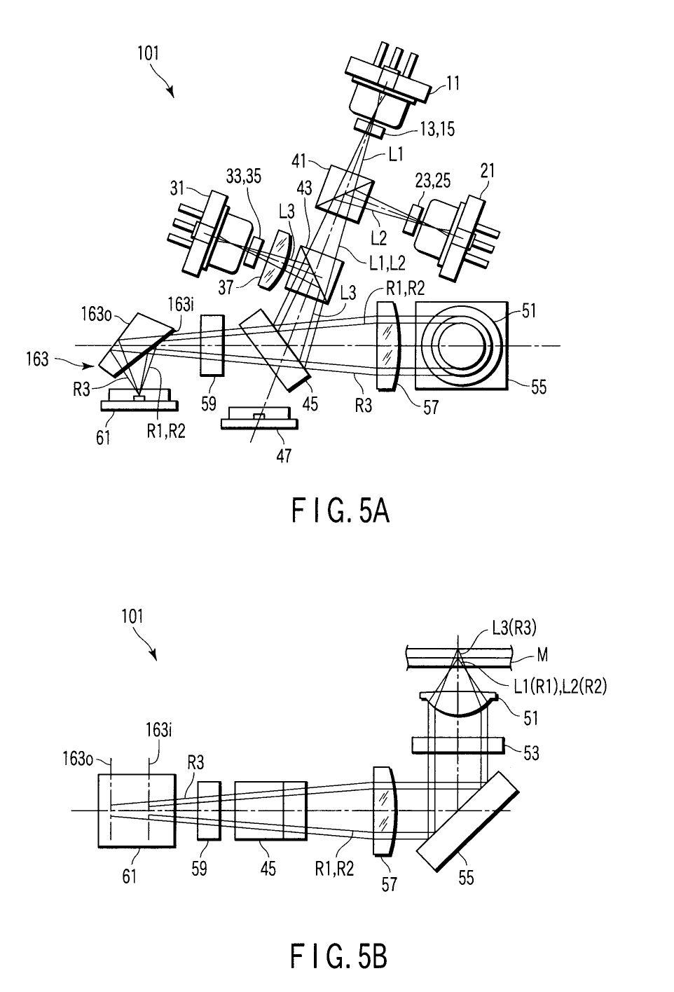

FIGS. 5A and 5B show another embodiment of the invention different from the optical pickup apparatus shown in FIGS. 1A and 1B. The same reference numbers are given to the same or similar elements of the optical pickup apparatus shown in FIGS. 1A and 1B, and the explanation on these elements will be simplified.

An optical pickup apparatus 101 shown in FIGS. 5A and 5B has a first semiconductor laser beam source 11 to emit a laser beam L1 of wavelength substantially 405 nm, a second semiconductor laser beam source 21 to emit a laser beam L2 of wavelength substantially 660 nm, and a third semiconductor laser beam source 31 to emit a laser beam L3 of wavelength substantially 780 nm.

When the loaded optical disc M is an HD DVD standard disc, the first laser beam source 11 emits the laser beam L1 of wavelength 405 nm. The laser beam L1 is passed through the prisms 41 and 43, partially reflected by the beam splitter 45, collimated by the collimator lens 57, changed in the advancing direction by the mirror 55, rotated 45° in the wavefront polarizing direction by the λ/4 plate 53, and guided to the objective lens 51.

The laser beam L1 guided to the objective lens 51 is converged (condensed) on the recording surface of the optical disc M by the power of the objective lens 51, changed in the polarizing direction depending on whether information is recorded on the recording surface, and returned to the objective lens 51 as a reflected laser beam R1.

The reflected laser beam R1 returned to the objective lens 51 is further rotated 45° in the wavefront polarizing direction by the λ/4 plate 53, reflected by the mirror 55, given convergence by the collimator lens 57, and returned to the beam splitter 45.

A predetermined ratio of the light amount of the reflected laser beam R1 returned to the beam splitter 45 is passed through the beam splitter 45, given a predetermined image forming characteristic by the astigmatic aberration sensor lens 59, reflected by a incident side plane 1631 of a non-parallel prism 163, and forms an image at a predetermined position in the PDIC 61.

When the loaded optical disc M is a DVD standard disc, the second laser beam source 21 emits the laser beam L2 of wavelength 660 nm. The laser beam L2 is reflected by the prism 41, guided to the prism 43 on the substantially same optical path as the laser beam L1 from the first laser beam source 11, passed through the prism 43, and guided to the beam splitter 45.

The laser beam L2 guided to the beam splitter 45 is partially reflected, collimated by the collimator lens 57, changed in the advancing direction by the mirror 55, rotated 45° in the wavefront polarizing direction by the λ/4 plate 53, and guided to the objective lens 51.

The laser beam L2 guided to the objective lens 51 is converged (condensed) on the recording surface of the optical disc M by the power of the objective lens 51, changed in the polarizing direction depending on whether information is recorded on the recording surface, and returned to the objective lens 51 as a reflected laser beam R2.

The reflected laser beam R2 returned to the objective lens 51 is further rotated 45° in the wavefront polarizing direction by the λ/4 plate 53, reflected by the mirror 55, given convergence by the collimator lens 57, and returned to the beam splitter 45.

A predetermined ratio of the light amount of the reflected laser beam R2 returned to the beam splitter 45 is passed through the beam splitter 45, given a predetermined image forming characteristic by the astigmatic aberration sensor lens 59, reflected by the incident side plane 1631 of the non-parallel prism 163, and forms an image at a predetermined position in the PDIC 61.

When the loaded optical disc M is a CD standard disc, the third laser beam source 31 emits the laser beam L3 of wavelength 780 nm. The laser beam L3 is reflected by the second prism 43, guided to the beam splitter 45 on the substantially same optical path as the laser beam L1 from the first laser beam source 11 and laser beam L2 from the second laser beam source 21.

As already explained in FIGS. 1A and 1B, because of the magnification change lens 37 added, though the laser beam L3 from the third laser beam source 31 is given a predetermined convergence by the collimator lens 57 when entering the objective lens 51, the laser beam L3 is given a predetermined convergence (divergency in the sectional diameter of the laser beam) to become the state that divergence is slightly held, and guided to the beam splitter 45.

The laser beam L3 guided to the beam splitter 45 is partially reflected, collimated by the collimator lens 57, changed in the advancing direction by the mirror 55, rotated 45° in the wavefront polarizing direction by the λ/4 plate 53, and guided to the objective lens 51.

The laser beam L3 guided to the objective lens 51 is converted from the divergent light to a convergent light by the power of the objective lens 51, and condensed on the recording surface of the optical disc M through a 1.2-mm transmissive layer.

The reflected laser beam R3 reflected from the recording surface of the optical disc M is returned to the objective lens 51 as a laser beam with the convergence less than the reflected laser beam that is the reflected first or second laser beam L1 or L2.

The reflected laser beam R3 returned to the objective lens 51 is further rotated 45° in the wavefront polarizing direction by the λ/4 plate 53, reflected by the mirror 55, given convergence by the collimator lens 57, and returned to the beam splitter 45.

A predetermined ratio of the light amount of the reflected laser beam R3 returned to the beam splitter 45 is passed through the beam splitter 45, given a predetermined image forming characteristic by the astigmatic aberration sensor lens 59, passed through the incident side plane 1631 of the non-parallel prism 163, reflected by an exit side plane 163o of the non-parallel prism 163, and forms an image at a predetermined position in the PDIC 61.

The incident side plane 1631 of the non-parallel prism 163 is required to substantially pass the reflected laser beam R3, or a laser beam in the 780-nm band, and to substantially reflect a laser beam in a shorter-wavelength band than the 660-nm band. Therefore, a not-shown dichroic film that is a multilayer thin optical film to invert a reflection characteristic in the of 700-750-nm band is used. The incident side plane 1631 is also required to have a size (area) to pass all sectional diameters of the laser beam R3 reflected from the exit side plane 163o. Namely, the incident side plane 1631 is preferably set to a size that only a part of the laser beam R3 reflected from the exit side plane 163o toward the PDIC 61 passes through the incident side plane 1631 (a part of the laser beam R3 does not come off the incident side plane 1631).

As explained above, by using the optical pickup apparatus 101 shown in FIGS. 5A and 5B, it is possible to correct the influence of fluctuations in the beam spot size when a reflected laser beam forms an image in the PDIC, resulting from the difference in the thickness of a layer (standards of the optical disc M) to pass a laser beam. Therefore, information can be stably reproduced from the optical disc M of different standards.

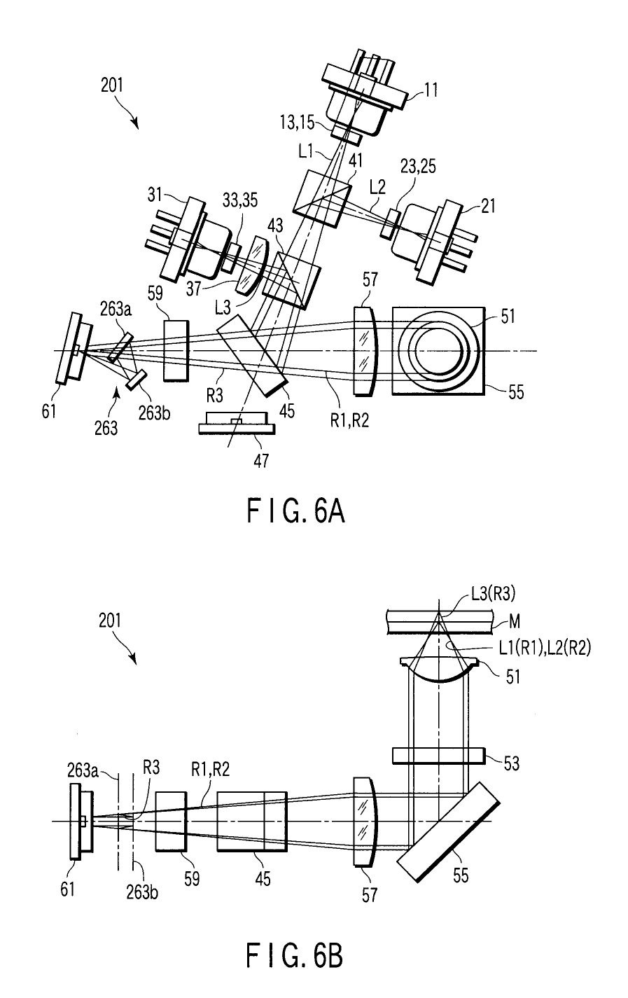

FIGS. 6A and 6B show still another embodiment of the invention different from the optical pickup apparatus shown in FIGS. 1A and 1B. The same reference numbers are given to the same or similar elements of the optical pickup apparatus shown in FIGS. 1A and 1B, and the explanation on these elements will be simplified.

An optical pickup apparatus 201 shown in FIGS. 6A and 6B has a first semiconductor laser beam source 11 to emit a laser beam L1 of wavelength substantially 405 nm, a second semiconductor laser beam source 21 to emit a laser beam L2 of wavelength substantially 660 nm, and a third semiconductor laser beam source 31 to emit a laser beam L3 of wavelength substantially 780 nm.

When the loaded optical disc M is an HD DVD standard disc, the first laser beam source 11 emits the laser beam L1 of wavelength 405 nm. The laser beam L1 is passed through the prisms 41 and 43, partially reflected by the beam splitter 45, collimated by the collimator lens 57, changed in the advancing direction by the mirror 55, rotated 45° in the wavefront polarizing direction by the λ/4 plate 53, and guided to the objective lens 51.

The laser beam L1 guided to the objective lens 51 is converged (condensed) on the recording surface of the optical disc M by the power of the objective lens 51, changed in the polarizing direction depending on whether information is recorded on the recording surface, and returned to the objective lens 51 as a reflected laser beam R1.

The reflected laser beam R1 returned to the objective lens 51 is further rotated 45° in the wavefront polarizing direction by the λ/4 plate 53, reflected by the mirror 55, given convergence by the collimator lens 57, and returned to the beam splitter 45.

A predetermined ratio of the light amount of the reflected laser beam R1 returned to the beam splitter 45 is passed through the beam splitter 45, given a predetermined image forming characteristic by the astigmatic aberration sensor lens 59, passed through the first mirror 263a of an infrared optical path length correction unit 263, and forms an image at a predetermined position in the PDIC 61. As described later, the PDIC 61 is preferably inclined by a predetermined angle θ to a line segment 201a extended from an axial line connecting the objective lens 51 and beam splitter 45, in order to increase the gain when receiving a laser beam of wavelength 780 nm for a CD-standard optical disc.

When the loaded optical disc M is a DVD-standard disc, the second laser beam source 21 emits the laser beam L2 of wavelength 660 nm. The laser beam L2 is reflected by the prism 41, guided to the prism 43 on the substantially same optical path as the laser beam L1 from the first laser beam source 11, passed through the prism 43, and guided to the beam splitter 45.

The laser beam L2 guided to the beam splitter 45 is partially reflected, collimated by the collimator lens 57, changed in the advancing direction by the mirror 55, rotated 45° in the wavefront polarizing direction by the λ/4 plate 53, and guided to the objective lens 51.

The laser beam L2 guided to the objective lens 51 is converged (condensed) on the recording surface of the optical disc M by the power of the objective lens 51, changed in the polarizing direction depending on whether information is recorded on the recording surface, and returned to the objective lens 51 as a reflected laser beam R2.

The reflected laser beam R2 returned to the objective lens 51 is further rotated 45° in the wavefront polarizing direction by the λ/4 plate 53, reflected by the mirror 55, given convergence by the collimator lens 57, and returned to the beam splitter 45.

A predetermined ratio of the light amount of the reflected laser beam R2 returned to the beam splitter 45 is passed through the beam splitter 45, given a predetermined image forming characteristic by the astigmatic aberration sensor lens 59, passed through the first mirror 263a of the infrared optical path length correction unit 263, and forms an image at a predetermined position in the PDIC 61.

When the loaded optical disc M is a CD-standard disc, the third laser beam source 31 emits the laser beam L3 of wavelength 780 nm. The laser beam L3 is reflected by the second prism 43, guided to the beam splitter 45 on the substantially same optical path as the laser beam L1 from the first laser beam source 11 and laser beam L2 from the second laser beam source 21.

As already explained in FIGS. 1A and 1B, because of the magnification change lens 37 added, though the laser beam L3 from the third laser beam source 31 is given a predetermined convergence by the collimator lens 57 when entering the objective lens 51, the laser beam L3 is given a predetermined convergence (divergency in the sectional diameter of the laser beam) to become the state that divergence is slightly held, and guided to the beam splitter 45.

The laser beam L3 guided to the beam splitter 45 is partially reflected, collimated by the collimator lens 57, changed in the advancing direction by the mirror 55, rotated 45° in the wavefront polarizing direction by the λ/4 plate 53, and guided to the objective lens 51.

The laser beam L3 guided to the objective lens 51 is converted from the divergent light to a convergent light by the power of the objective lens 51, and condensed on the recording surface of the optical disc M through a 1.2-mm transmissive layer.

The reflected laser beam R3 reflected from the recording surface of the optical disc M is returned to the objective lens 51 as a laser beam with the convergence less than the reflected laser beam that is the reflected first or second laser beam L1 or L2.

The reflected laser beam R3 returned to the objective lens 51 is further rotated 45° in the wavefront polarizing direction by the λ/4 plate 53, reflected by the mirror 55, given convergence by the collimator lens 57, and returned to the beam splitter 45.

A predetermined ratio of the light amount of the reflected laser beam R3 returned to the beam splitter 45 is passed through the beam splitter 45, given a predetermined image forming characteristic by the astigmatic aberration sensor lens 59, once folded to the beam splitter 45 by the first mirror 263a of the infrared optical path length correction unit 263, reflected again toward the PDIC 61 by a second mirror 263b, and forms an image at a predetermined position in the PDIC 61. As the PDIC 61 is inclined by an angle θ to the line segment 201a extended from the axial line connecting the objective lens 51 and beam splitter 45, even when receiving the reflected laser beam R that is reflected by the second mirror 263b of the infrared optical path length correction unit 263 and guided to the light-receiving plane of the PDIC 61 obliquely to the axial line 201a, the PDIC 61 is prevented from outputting an undesirably low photoelectric conversion output.

The first mirror 263a of the infrared optical path length correction unit 263 is required to substantially pass the reflected laser beam R3 or a laser beam in the 780-nm band, and to reflect a laser beam in a shorter-wavelength band than the 660-nm band. Thus, for example, a not-shown dichroic film that is a multilayer optical thin film to invert a reflection characteristic in the 700- to 750-nm band is used.

The first mirror 263a is defined to a size not to interrupt the optical path of the laser beam R3 in the 780-nm band reflected by the second mirror 263b and directed to the PDIC 61. Namely, the third laser beam R is reflected by the second mirror 263b and first mirror 263a, and guided to the PDIC 61. The other laser beams (R1 and R2) are required only to pass through the first mirror 263a in designing an optical path. Therefore, the first mirror 263a may be defined to a minimum size to reflect the laser beam R3. In this case, the weight of the mirror 26s is reduced.

As explained above, by using the optical pickup apparatus 201 shown in FIGS. 6A and 6B, it is possible to correct the influence of fluctuations in the beam spot size when a reflected laser beam forms an image in the PDIC, resulting from the difference in the thickness of a layer to pass a laser beam. Further, concerning the inclination to the light-receiving surface of the PDIC occurring as a result of correcting the optical length of the 780-nm-band laser beam for a CD-standard optical disc, the photoelectric conversion efficiency is increased by inclining the PDIC, and information can be stably reproduced from the optical disc M of different standards.

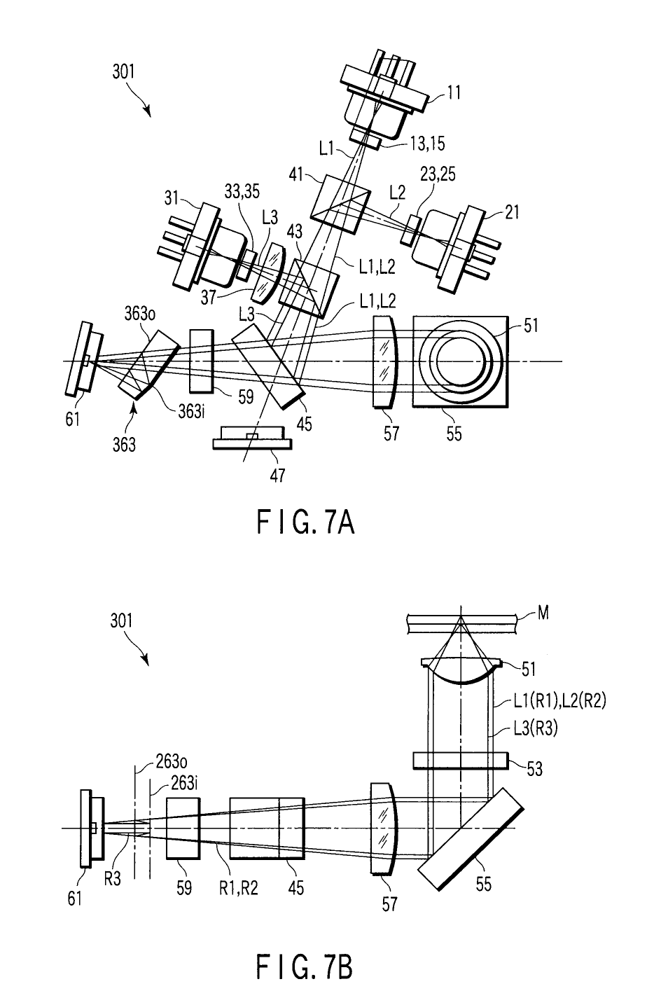

FIGS. 7A and 7B show still another embodiment of the invention different from the optical pickup apparatus shown in FIGS. 1A and 1B. The same reference numbers are given to the same or similar elements of the optical pickup apparatus shown in FIGS. 1A and 1B, and the explanation on these elements will be simplified.

An optical pickup apparatus 301 shown in FIGS. 7A and 7B has a first semiconductor laser beam source 11 to emit a laser beam L1 of wavelength substantially 405 nm, a second semiconductor laser beam source 21 to emit a laser beam L2 of wavelength substantially 660 nm, and a third semiconductor laser beam source 31 to emit a laser beam L3 of wavelength substantially 780 nm.

When the loaded optical disc M is an HD DVD standard disc, the first laser beam source 11 emits the laser beam L1 of wavelength 405 nm. The laser beam L1 is passed through the prisms 41 and 43, partially reflected by the beam splitter 45, collimated by the collimator lens 57, changed in the advancing direction by the mirror 55, rotated 45° in the wavefront polarizing direction by the λ/4 plate 53, and guided to the objective lens 51.

The laser beam L1 guided to the objective lens 51 is converged (condensed) on the recording surface of the optical disc M by the power of the objective lens 51, changed in the polarizing direction depending on whether information is recorded on the recording surface, and returned to the objective lens 51 as a reflected laser beam R1.

The reflected laser beam R1 returned to the objective lens 51 is further rotated 45° in the wavefront polarizing direction by the λ/4 plate 53, reflected by the mirror 55, given convergence by the collimator lens 57, and returned to the beam splitter 45.

A predetermined ratio of the light amount of the reflected laser beam R1 returned to the beam splitter 45 is passed through the beam splitter 45, given a predetermined image forming characteristic by the astigmatic aberration sensor lens 59, passed through the incident plane 3631 and exit plane 363o of an infrared optical path length correction prism 363, and forms an image at a predetermined position in the PDIC 61. As described later, the PDIC 61 is preferably inclined by a predetermined angle φ to a line segment 301a extended from an axial line connecting the objective lens 51 and beam splitter, in order to increase the gain when receiving a laser beam of wavelength 780 nm for a CD-standard optical disc.

When the loaded optical disc M is a DVD-standard disc, the second laser beam source 21 emits the laser beam L2 of wavelength 660 nm. The laser beam L2 is reflected by the prism 41, guided to the prism 43 on the substantially same optical path as the laser beam L1 from the first laser beam source 11, passed through the prism 43, and guided to the beam splitter 45.

The laser beam L2 guided to the beam splitter 45 is partially reflected, collimated by the collimator lens 57, changed in the advancing direction by the mirror 55, rotated 45° in the wavefront polarizing direction by the λ/4 plate 53, and guided to the objective lens 51.

The laser beam L2 guided to the objective lens 51 is converged (condensed) on the recording surface of the optical disc M by the power of the objective lens 51, changed in the polarizing direction depending on whether information is recorded on the recording surface, and returned to the objective lens 51 as a reflected laser beam R2.

The reflected laser beam R2 returned to the objective lens 51 is further rotated 45° in the wavefront polarizing direction by the λ/4 plate 53, reflected by the mirror 55, given convergence by the collimator lens 57, and returned to the beam splitter 45.

A predetermined ratio of the light amount of the reflected laser beam R2 returned to the beam splitter 45 is passed through the beam splitter 45, given a predetermined image forming characteristic by the astigmatic aberration sensor lens 59, passed through the incident plane 3631 and exit plane 363o of the infrared optical path length correction prism 363, and forms an image at a predetermined position in the PDIC 61.

When the loaded optical disc M is a CD-standard disc, the third laser beam source 31 emits the laser beam L3 of wavelength 780 nm. The laser beam L3 is reflected by the second prism 43, guided to the beam splitter 45 on the substantially same optical path as the laser beam L1 from the first laser beam source 11 and laser beam L2 from the second laser beam source 21.

As already explained in FIGS. 1A and 1B, because of the magnification change lens 37 added, though the laser beam L3 from the third laser beam source 31 is given a predetermined convergence by the collimator lens 57 when entering the objective lens 51, the laser beam L3 is given a predetermined convergence (divergence in the sectional diameter of the laser beam) to become the state that divergence is slightly held, and guided to the beam splitter 45.

The laser beam L3 guided to the beam splitter 45 is partially reflected, collimated by the collimator lens 57, changed in the advancing direction by the mirror 55, rotated 45° in the wavefront polarizing direction by the λ/4 plate 53, and guided to the objective lens 51.

The laser beam L3 guided to the objective lens 51 is converted from the divergent light to a convergent light by the power of the objective lens 51, and condensed on the recording surface of the optical disc M through a 1.2-mm transmissive layer.

The reflected laser beam R3 reflected from the recording surface of the optical disc M is returned to the objective lens 51 as a laser beam with the convergence less than the reflected laser beam that is the reflected first or second laser beam L1 or L2.

The reflected laser beam R3 returned to the objective lens 51 is further rotated 45° in the wavefront polarizing direction by the λ/4 plate 53, reflected by the mirror 55, given convergence by the collimator lens 57, and returned to the beam splitter 45.

A predetermined ratio of the light amount of the reflected laser beam R3 returned to the beam splitter 45 is passed through the beam splitter 45, given a predetermined image forming characteristic by the astigmatic aberration sensor lens 59, passed through a first area 363ic of the incident plane 3631 of the infrared optical length correction prism 363 including the line segment 301a extended from the axial line connecting the objective lens 51 and beam splitter 45, reflected from the exit plane 363o, reflected again toward the PDIC 61 in a second area 363 of the incident plane 3631 not including the first area 363ic, and forms an image at a predetermined position in the PDIC 61. The first area 363ic of the incident plane 3631 of the infrared optical path length correction prism 363 is required to substantially pass the reflected laser beam R3 that is a laser beam in the 780-nm band, and to reflect a laser beam in a shorter-wavelength band than the 660-nm band. Thus, for example, a not-shown dichroic film that is a multilayer optical thin film to invert a reflection characteristic in the 700- to 750-nm band is used. In the second area 363 is of the exit plane 363o and incident plane 3631, a not-shown dichroic film that is a multilayer optical thin film capable of reflecting a laser beam in the 780-nm band is used.

As the PDIC 61 is inclined by an angle φ to the line segment 301a extended from the axial line connecting the objective lens 51 and beam splitter 45, even when receiving the reflected laser beam R that is reflected by the incident plane 363 is of the infrared optical path length correction prism 363 and guided to the light-receiving plane of the PDIC 61 obliquely to the axial line 301a, the PDIC 61 is prevented from outputting an undesirably low photoelectric conversion output.

As explained above, by using the optical pickup apparatus 301 shown in FIGS. 7A and 7B, it is possible to correct the influence of fluctuations in the beam spot size when a reflected laser beam forms an image in the PDIC, resulting from the difference in the thickness of a layer to pass a laser beam. Further, concerning the inclination to the light-receiving surface of the PDIC occurring as a result of correcting the optical length of the 780-nm-band laser beam for a CD-standard optical disc, the photoelectric conversion efficiency is increased by inclining the PDIC, and information can be stably reproduced from the optical disc M regardless of the standard.

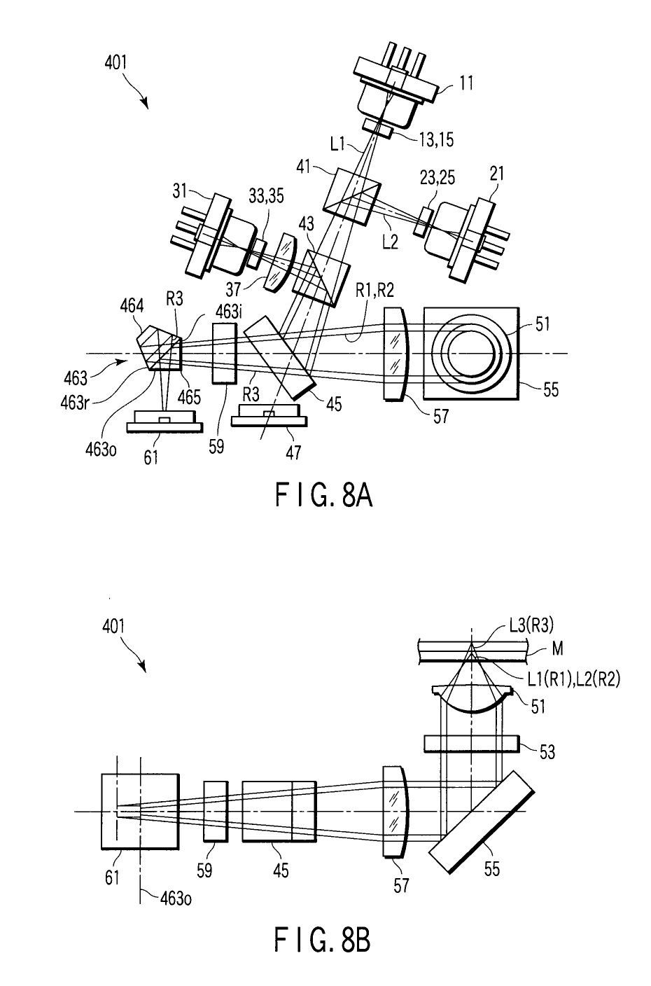

FIGS. 8A and 8B show still another embodiment of the invention different from the optical pickup apparatus shown in FIGS. 1A and 1B. The same reference numbers are given to the same or similar elements of the optical pickup apparatus shown in FIGS. 1A and 1B, and the explanation on these elements will be simplified.

An optical pickup apparatus 401 shown in FIGS. 7A and 7B has a first semiconductor laser beam source 11 to emit a laser beam L1 of wavelength substantially 405 nm, a second semiconductor laser beam source 21 to emit a laser beam L2 of wavelength substantially 660 nm, and a third semiconductor laser beam source 31 to emit a laser beam L3 of wavelength substantially 780 nm.

When the loaded optical disc M is an HD-DVD-standard disc, the first laser beam source 11 emits the laser beam L1 of wavelength 405 nm. The laser beam L1 is passed through the prisms 41 and 43, partially reflected by the beam splitter 45, collimated by the collimator lens 57, changed in the advancing direction by the mirror 55, rotated 45° in the wavefront polarizing direction by the λ/4 plate 53, and guided to the objective lens 51.

The laser beam L1 guided to the objective lens 51 is converged (condensed) on the recording surface of the optical disc M by the power of the objective lens 51, changed in the polarizing direction depending on whether information is recorded on the recording surface, and returned to the objective lens 51 as a reflected laser beam R1.

The reflected laser beam R1 returned to the objective lens 51 is further rotated 45° in the wavefront polarizing direction by the λ/4 plate 53, reflected by the mirror 55, given convergence by the collimator lens 57, and returned to the beam splitter 45.

A predetermined ratio of the light amount of the reflected laser beam R1 returned to the beam splitter 45 is passed through the beam splitter 45, given a predetermined image forming characteristic by the astigmatic aberration sensor lens 59, and reflected to the PDIC 61 by the infrared optical path length correction prism 463. The infrared optical path length correction prism 463 is formed by a trapezoidal prism 464 and a triangular (rectangular) prism 465. The longest side of the triangular prism 465 is joined to the longer side of the parallel sides of the trapezoidal prism 464, providing a first reflection plane 463r. Two sides holding the right angle of the triangular prism 465 are assigned to an incident plane 4631 and an exit plane 463o.

In particular, the reflected R1 passes through the incident plane 4631, and reflected toward the PDIC 61 on the first reflection plane 463r. The triangular prism 465 may be omitted. In such a case, the reflected laser beam R1 is of course reflected from the first reflection plane 463r.

When the loaded optical disc M is a DVD-standard disc, the second laser beam source 21 emits the laser beam L2 of wavelength 660 nm. The laser beam L2 is reflected by the prism 41, guided to the prism 43 on the substantially same optical path as the laser beam L1 from the first laser beam source 11, passed through the prism 43, and guided to the beam splitter 45.

The laser beam L2 guided to the beam splitter 45 is partially reflected, collimated by the collimator lens 57, changed in the advancing direction by the mirror 55, rotated 45° in the wavefront polarizing direction by the λ/4 plate 53, and guided to the objective lens 51.

The laser beam L2 guided to the objective lens 51 is converged (condensed) on the recording surface of the optical disc M by the power of the objective lens 51, changed in the polarizing direction depending on whether information is recorded on the recording surface, and returned to the objective lens 51 as a reflected laser beam R2.

The reflected laser beam R2 returned to the objective lens 51 is further rotated 45° in the wavefront polarizing direction by the λ/4 plate 53, reflected by the mirror 55, given convergence by the collimator lens 57, and returned to the beam splitter 45.

A predetermined ratio of the light amount of the reflected laser beam R2 returned to the beam splitter 45 is passed through the beam splitter 45, given a predetermined image forming characteristic by the astigmatic aberration sensor lens 59, passed through the incident plane 4631 of the infrared optical path length correction prism 463, and forms an image at a predetermined position in the PDIC 61 on the first reflection plane 463r. When the triangular prism 463 is omitted, the reflected laser beam R1 is reflected from the first reflection plane 463r.

When the loaded optical disc M is a CD-standard disc, the third laser beam source 31 emits the laser beam L3 of wavelength 780 nm. The laser beam L3 is reflected by the second prism 43, guided to the beam splitter 45 on the substantially same optical path as the laser beam L1 from the first laser beam source 11 and laser beam L2 from the second laser beam source 21.

As already explained in FIGS. 1A and 1B, because of the magnification change lens 37 added, though the laser beam L3 from the third laser beam source 31 is given a predetermined convergence by the collimator lens 57 when entering the objective lens 51, the laser beam L3 is given a predetermined convergence (divergence in the sectional diameter of the laser beam) to become the state that divergence is slightly held, and guided to the beam splitter 45.

The laser beam L3 guided to the beam splitter 45 is partially reflected, collimated by the collimator lens 57, changed in the advancing direction by the mirror 55, rotated 45° in the wavefront polarizing direction by the λ/4 plate 53, and guided to the objective lens 51.

The laser beam L3 guided to the objective lens 51 is converted from the divergent light to a convergent light by the power of the objective lens 51, and condensed on the recording surface of the optical disc M through a 1.2-mm transmissive layer.

The reflected laser beam R3 reflected from the recording surface of the optical disc M is returned to the objective lens 51 as a laser beam with the convergence less than the reflected laser beam that is the reflected first or second laser beam L1 or L2.

The reflected laser beam R3 returned to the objective lens 51 is further rotated 45° in the wavefront polarizing direction by the λ/4 plate 53, reflected by the mirror 55, given convergence by the collimator lens 57, and returned to the beam splitter 45.

A predetermined ratio of the light amount of the reflected laser beam R3 returned to the beam splitter 45 is passed through the beam splitter 45, given a predetermined image forming characteristic by the astigmatic aberration sensor lens 59, passed through the incident plane 4631 of the infrared optical path length correction prism 463 (triangular prism) and first reflection plane (connection surface) 463r, reflected sequentially on two non-parallel planes of the trapezoidal prism 464, passed from the trapezoidal prism 464 to triangular prism 465 on the first reflection plane (connection surface) 463r, passed through exit plane 463o (triangular prism), and guided to the PDIC 61.

The incident plane 4631 of the infrared optical path length correction prism 463 (triangular prism), first reflection plane (connection surface) 463r and exit plane 463o (triangular prism) are required to substantially pass a the reflected laser beam R3 or a laser beam in the 780-nm band, and to reflect a laser beam in a shorter-wavelength band than the 660-nm band. Thus, for example, a not-shown dichroic film that is a multilayer optical thin film to invert a reflection characteristic in the 700- to 750-nm band is used.

As explained above, by using the optical pickup apparatus 401 shown in FIGS. 8A and 8B, it is possible to correct the influence of fluctuations in the beam spot size when a reflected laser beam forms an image in the PDIC, resulting from the difference in the thickness of a layer to pass a laser beam. Therefore, information can be stably reproduced from the optical disc M regardless of the standard.

FIG. 9 is a schematic diagram showing an example of an information recording/reproducing apparatus (optical disc drive) incorporating the optical pickup apparatus explained with reference to FIGS. 1, and 5-8.

An optical information recording/reproducing apparatus 1001 includes a main control unit (CPU) 1021 connected to a control bus 1011, a random access memory (RAM) 1023 holding data for data processing, and a read-only memory (ROM) 1025 including a prerecorded operation program.

The control bus 1011 is connected to a disc motor 1101 to rotate an optical disc (medium) M at a predetermined number of revolutions through a disc motor control circuit 1201. Therefore, the optical disc M is rotated at a predetermined speed by the disc motor 1101 controlled by the CPU 1011.

The control bus 1011 is connected to a feed motor 1111 which moves the optical pickup apparatus 1 (101, 201, 301 and 401) along the recording surface of the (loaded) optical disc M, through a motor control circuit 1211. Therefore, the optical pickup apparatus 1 (101, 201, 301 and 401) and reciprocated along the radial direction of the recording surface of an optical disc under the control of the CPU 1011.

The intensity of a laser beams L1, L2 or L3 from an optional semiconductor laser beam source (11, 21, 31) is detected by a PDIC 47 for monitoring, and fed back to a laser power control circuit 1261. A laser drive signal supplied from the laser power control circuit 1261 to each laser beam source is modulated in intensity by a laser modulation signal corresponding to data to be recorded from a recording data generation circuit 1031, when writing information in an optical disc.

Reflected laser beams R1, R2 and R3 received by the PDIC 61 is supplied to a data reproducing circuit 1267 as outputs added by outputs from each detection cell of a 4-divided detection cell 61C receiving a 0-order light (non-diffracted light). The output of each detection cell applied to the data reproducing circuit 1267 is supplied to an error correction circuit 1041 under the control of the CPU 1021, and after an error is corrected, the output is transferred to the RAM 1023 as data recorded in the optical disc M. The output of the data reproducing circuit 1267 is also supplied to a PLL control circuit 1269 to control the number of revolutions of the optical disc M (the number of revolutions of the disc motor 1101).

The outputs from the not-adjacent detection cells of the 4-divided detection cell 61C are added by an adder 1251 to generate a focus error signal by astigmatic aberration of one of the four detection cells, and supplied to a focusing control circuit 1263. The focus error control signal generated by the focusing control circuit 1263 is supplied to a focus control coil 1121 for moving the objective lens 51 in the direction perpendicular to the recording surface of the optical disc M.

Among the outputs from the detection cells of the 4-divided detection cell 61C, outputs of two adjacent detection cells combined to project a recording mark string that is information prerecorded in the optical disc M or a signal including a reflection component of a guide groove are added by an adder 1253, in order to generate a correction signal for canceling the influence of inclination of the recording surface of the optical disc M or lens shift of the objective lens 51.

On the other hand, among the outputs of two 4-divided detection cells 61L and 61R to detect a ±1^{st} order light, outputs of two adjacent detection cells combined to project a recording mark string that is information prerecorded in the optical disc M or a signal including a reflection component of a guide groove are added by an adder 1255, added to the output of the adder 1253 by an adder 1257, and supplied to a tracking control circuit 1265, which controls tracking for matching the position of the objective lens 51 parallel to the recording surface of the optical disc M and located in the radial direction of the optical disc M, to a laser beam passing through the center of the objective lens 51. The track error control signal generated by the tracking control circuit 1265 is supplied to a track control coil 1123 for moving the objective lens 51 in the radial direction of the recording surface of the optical disc M, and along the recording surface of the optical disc M.

As explained hereinbefore, according to an embodiment of the invention, there is provided an optical pickup apparatus and an optical information recording/reproducing apparatus, which can play an HD-DVD-standard optical disc capable of recording at a super-high recording density, and the widely used DVD- and CD-standard optical discs, with a one-channel light-receiving element.

Namely, there is provided an optical pickup apparatus and an optical information recording/reproducing apparatus, which can ensure detection sensitivity higher than a certain level for laser beams with two or more wavelengths.

Therefore, it is possible to correct the influence of fluctuations in the beam spot size when a reflected laser beam forms an image in a light-receiving unit, resulting from the difference in the thickness of a layer to pass a laser beam.

Further, information can be stably reproduced from recording media of different standards with a single light-receiving unit.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical pickup apparatus comprising:
an objective lens for condensing a laser beam on a recording surface of a recording medium;
a collimator lens for collimating a laser beam guided to the objective lens;
a magnification change lens which gives a predetermined convergence to a laser beam guided from a light source to the collimator lens, and leaves divergence after the laser beam passes through the collimator lens; and
an optical path length correction mechanism for changing an optical path length of a reflected laser beam that is a laser beam condensed and reflected from the recording surface of the recording medium through the magnification change lens.

2. The optical pickup apparatus according to claim 1, wherein the optical path length correction mechanism equivalently increases an optical path length of a reflected laser beam that is a laser beam condensed and reflected from the recording surface of the recording medium through the magnification change lens.

3. The optical pickup apparatus according to claim 1, wherein a laser beam condensed on the recording surface of the recording medium through the magnification change lens is a laser beam with a wavelength suitable for a recording medium having a long distance to a recording surface.

4. The optical pickup apparatus according to claim 2, wherein a laser beam condensed on the recording surface of the recording medium through the magnification change lens is a laser beam with a wavelength suitable for a recording medium having a long distance to a recording surface.

5. The optical pickup apparatus according to claim 1, wherein a laser beam condensed on the recording surface of the recording medium through the magnification change lens is a laser beam with a wavelength suitable for a recording medium having a thick light-transmitting layer.

6. The optical pickup apparatus according to claim 2, wherein a laser beam condensed on the recording surface of the recording medium through the magnification change lens is a laser beam with a wavelength suitable for a recording medium having a thick light-transmitting layer.

7. An optical pickup apparatus comprising:
a first light source to emit a laser beam with a first wavelength for recording or reproducing information in/from a first-standard recording medium with a first thickness of a light-transmitting layer to a recording layer;
a second light source to emit a laser beam with a second wavelength longer than the first wavelength for recording or reproducing information in/from a second-standard recording medium with a second thickness of a light-transmitting layer to a recording layer thicker than the first-standard recording medium;
an objective lens for condensing laser beams from the first and second light sources on a recording surface of a recording medium;
a collimator lens for collimating a laser beam guided to the objective lens;
a magnification change lens which gives a predetermined convergence to a laser beam guided from the second light source to the collimator lens, and leaves divergence after the laser beam passes through the collimator lens; and
an optical path length correction mechanism which increases the optical path length of a first reflected laser beam that is a laser beam emitted from the second light source and condensed on the recording surface of the recording medium, comparing with the optical path length of a second reflected laser beam that is a laser beam emitted from the first light source and condensed on the recording surface of the recording medium.

8. The optical pickup apparatus according to claim 7, wherein a wavelength of a laser beam from the first light source is 405 or 660 nm in center wavelength, and a wavelength of a laser beam from the second light source is 780 nm in center wavelength.

9. An optical pickup apparatus comprising:
a first semiconductor laser beam source for emitting a first laser beam in the 405-nm band;
a second semiconductor laser beam source for emitting a second laser beam in the 660-nm band;
a third semiconductor laser beam source for emitting a third laser beam in the 780-nm band;
an objective lens for condensing the first to third laser beams on a recording surface of a recording medium;
a collimator lens for collimating a laser beam guided to the objective lens;
a magnification change lens which gives a predetermined convergence to the third laser beam emitted from the third semiconductor laser beam source, and leaves divergence after the laser beam passes through the collimator lens;
an optical path length correction mechanism which increases the optical path length of a reflected laser beam that is the third laser beam condensed and reflected from the recording surface of the recording medium through the magnification change lens, to larger than the first and second laser beams; and
a photoelectric conversion element which detects a reflected laser beam reflected from the recording surface of the recording medium, and outputs an output corresponding to the intensity of the reflected laser beam.
